(19) United States
(12) Patent Application Publication
(10) Pub. No.: US 2008/0097759 A1
(43) Pub. Date: Apr. 24, 2008

(54) METHOD AND APPARATUS FOR REMOTE CONTROL IN PORTABLE TERMINAL

(75) Inventor: Jeong-Ho SHIN, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/870,188

(22) Filed: Oct. 10, 2007

(30) Foreign Application Priority Data
Oct. 24, 2006 (KR) 2006-0103235

(51) Int. Cl. G10L 15/00; H04M 1/02; H04M 11/10

(52) U.S. Cl. 704/246; 455/413; 455/566

(57) ABSTRACT

Provided is a method and apparatus for remotely controlling a second-party terminal in a portable terminal during call communication. The method includes transmitting a screen displayed in a display unit to the second-party terminal when a remote control event is created, and recognizing a speech signal transmitted from the second-party terminal and executing an operation corresponding to the speech signal.

### PRIORITY

This application claims priority under 35 U.S.C. § 119 to an application filed in the Korean Intellectual Property Office on Oct. 24, 2006 and assigned Serial No. 2006-103235, the contents of which are incorporated herein by reference.

### BACKGROUND OF THE INVENTION

1. Field of the Invention

The present invention relates generally to a remote control method and apparatus in a portable terminal, and, in particular, to a method and apparatus for remotely controlling a portable terminal of a second party, which will be referred to herein as a second-party terminal, by using a speech recognition function in a portable terminal during communication.

2. Description of the Related Art

Recent drastic development in mobile communication systems have brought portable terminals with a variety of functions to the market. The portable terminals provide such functions as games, a scheduler, a phonebook, morning call, Moving Picture Experts Group (MPEG) Layer 3 (MP3), a moving picture player, a digital camera and the like.

However, some people, including senior citizens and those who are visually handicapped, have difficulty manipulating the portable terminal and use only part of the diverse functions, such as a call communication function only, leaving most of the functions unused.

A conventional technology provides a portable terminal manipulating method between portable terminals based on a Dual Tone Multiple Frequency (DTMF) tone for those who can hardly use the diverse functions such as senior citizens and persons with visual handicaps. The DTMF tone signifies a frequency signal generated when a button in the portable terminal is pressed. A portable terminal can be remotely controlled using the DTMF tone. When a predetermined key button is pressed in a portable terminal to create a frequency corresponding to the key button, a second-party terminal executes an operation corresponding to the frequency.

A user should exactly know the operation of the second-party terminal that corresponds to each key button and press an accurate key button corresponding to a desired operation to manipulate or control the second-party terminal based on the DTMF tone. However, it is difficult for the user to memorize the operation of the second-party terminal that corresponds to each key button, and the action of pressing key buttons during call communication may be uncomfortable.

### SUMMARY OF THE INVENTION

An aspect of the present invention is to substantially solve at least the above problems and/or disadvantages and to provide at least the advantages below. Accordingly, an aspect of the present invention is to provide a method and apparatus for remotely controlling a portable terminal of a second party, i.e., a second-party terminal, in a portable terminal.

Another aspect of the present invention is to provide a method and apparatus for remotely controlling a second-party terminal by using a speech recognition function in a portable terminal during call communication.

According to one aspect of the present invention, a method of receiving a remote control from a second-party terminal is provided. The method includes transmitting a screen displayed in a display unit to the second-party terminal when a remote control event is created, and recognizing a speech signal received from the second-party terminal and executing an operation corresponding to the speech signal.

According to another aspect of the present invention, a method for remotely controlling a second-party terminal is provided. The method includes, when a remote control event is created, displaying a screen of the second-party terminal received from the second-party terminal in a predetermined position of a display unit, and transmitting a speech signal input from a user to the second-party terminal.

According to yet another aspect of the present invention, an apparatus of a portable terminal capable of being remotely controlled by a second-party terminal is provided. The apparatus includes a display unit for displaying information generated during an operation of the portable terminal, a controller for outputting a screen displayed in the display unit to a transceiver when a remote control event is created, analyzing a speech signal received from the second-party terminal, and executing an operation corresponding to the speech signal, and a transceiver for transmitting/receiving the screen and the speech signal to/from the second-party terminal.

According to still another aspect of the present invention, an apparatus of a portable terminal capable of remotely controlling a second-party terminal is provided. The apparatus includes a transceiver for transmitting/receiving a screen and a speech signal to/from the second-party terminal, a display unit for displaying a screen of the second-party terminal received from the second-party terminal in a predetermined position, and a speech input unit for receiving a speech signal from a user and outputting the speech signal to the transceiver.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to the present invention;

FIG. 2 is a flowchart of a process of remotely controlling a second-party terminal in a portable terminal during call communication according to the present invention; and

FIG. 3 is a flowchart of a process of receiving a remote control from a second-party terminal during call communication according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a method and apparatus for remotely controlling a second-party terminal in a portable terminal of a first party based on a speech recognition function during call communication is described. In the present invention described below, since a portable terminal executing a remote control displays the same screen as the second-party terminal receiving the remote control, a user can check a remote control execution result. Herein, the portable terminal may use a video communication service or a multimedia message service to display the same screen as that of the second-party terminal. For conciseness, an example utilizing the multimedia message service is described, though the invention is not so limited.

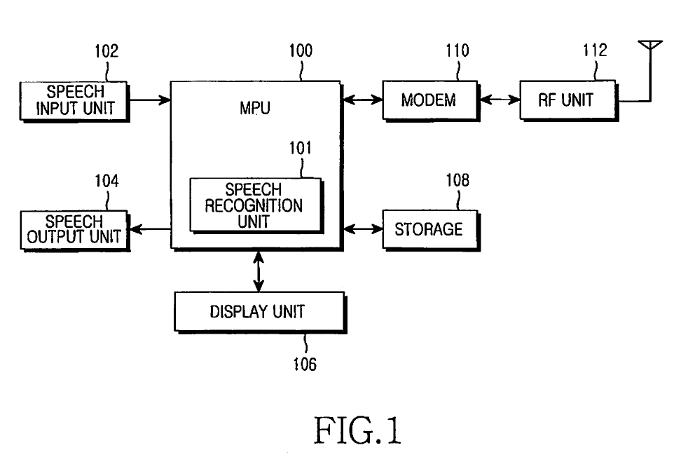

FIG. 1 is a block diagram of a portable terminal according to the present invention. Herein, the portable terminal includes a Micro Processing Unit (MPU) 100, a speech recognition unit 101, a speech input unit 102, a speech output unit 104, a display unit 106, storage 108, a modem 110 and a radio frequency (RF) unit 112.

Referring to FIG. 1, the MPU 100 performs general operation of the portable terminal. Specifically, the MPU 100 processes and controls the operation for speech communication and data communication, and executes an operation for remotely controlling the second-party terminal during call communication according to the present invention, and controls and processes functions for operation according to the remote control from the second-party terminal during communication. In short, when an event for remotely controlling the second-party terminal is created, the MPU 100 transmits a signal for requesting remote control to the second-party terminal, processes functions for receiving an acknowledgement signal thereto. When the second-party terminal permits the remote control, the MPU 100 controls and processes functions for remotely controlling the second-party terminal by using speech commands. Also, when the second-party terminal permits the remote control, the MPU 100 performs an authentication process to determine whether the second-party terminal is registered for remote control. When the second-party terminal is registered for remote control, the MPU 100 receives a speech command for remote control from the second-party terminal, and controls and processes functions for executing the operation according to the speech command. Particularly, the MPU 100 analyzes and recognizes the speech command input through the speech input unit 102 including the speech recognition unit 101, searches the storage 108 for an operation corresponding to the recognized speech command, and processes a function for executing the operation.

The speech input unit 102 converts analog speech signals input through a microphone into Pulse Code Modulation (PCM) data and provides the PCM data to the MPU 100. Particularly, the speech input unit 102 receives through a microphone a speech command spoken by the user or a speech command output from the speech output unit 104 through a speaker and provides the speech command to the MPU 100.

The speech output unit 104 converts the PCM data from the MPU 100 into analog speech signals and outputs the speech signals through a speaker. Particularly, a speech command is received from the second-party terminal during call communication from the MPU 100 and output through a speaker.

The display unit 106 displays status information generated during the operation of the portable terminal, a limited number of characters, and a large amount of moving pictures and still images. The display unit 106 is preferably a Liquid Crystal Display (LCD). Particularly, when the portable terminal is remotely controlled by the second-party terminal during call communication, the display unit 106 receives from the MPU 100 and displays a speech command execution result, and provides the display screen to the MPU 100.

The storage 108 may be a Read Only Memory (ROM), a Random Access Memory (RAM), a flash ROM and the like. The storage 108 stores a program for processing and controlling the MPU 100 and stores diverse data. Particularly, the storage 108 of the present invention stores operations or key buttons each of which corresponds to a speech command input by the user.

The modem 110 includes a coder, a decoder, a modulator and a demodulator, and codes signals input from the MPU 100, modulates coded data, and outputs the coded data to the RF unit 112. The modem 110 also performs modulation and demodulation onto the signals input from the RF unit 112, and provides resultant signals to the MPU 100.

The RF unit 112 processes data transmitted/received in a wireless channel environment. In other words, the RF unit 112 converts baseband signals input from the modem 110 into RF signals, which are higher than the baseband signals, outputs the RF signals into the wireless channel environment through an antenna, converts RF signals received through the antenna into baseband signals, and outputs the baseband signals into the modem 110.

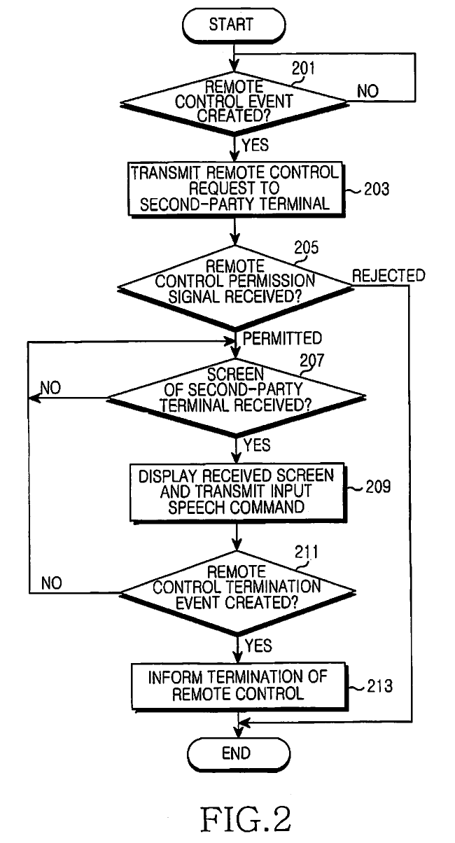

FIG. 2 is a flowchart of a process of remotely controlling a second-party terminal in a portable terminal of a first party during call communication according to the present invention. Referring to FIG. 2, the portable terminal checks whether an event for remotely controlling a second-party terminal in call communication is created in step 201. When an event for remotely controlling the second-party terminal is created, the portable terminal transmits a remote control request to the second-party terminal during call communication in step 203. In other words, the portable terminal transmits a signal for authenticating that the portable terminal has an authentication for remotely controlling the second-party terminal. Subsequently, the portable terminal checks in step 205 whether it receives a remote control permission signal from the second-party terminal.

When the portable terminal receives a remote control permission signal in step 205, the portable terminal checks in step 207 whether it receives screen data of the second-party terminal. In other words, the portable terminal checks whether it receives a multimedia message including screen data displayed in the display unit 106 of the second-party terminal. When the portable terminal receives the screen data, it displays the received screen in a predetermined position of its display unit 106 in step 209 and transmits a speech command input through the speech input unit 102 to the second-party terminal.

Subsequently, the portable terminal checks in step 211 whether an event for terminating the remote control is created. When the remote control termination event is not created, the portable terminal returns to the step 207 and checks whether screen data displaying the speech command execution result is received from the second-party terminal and repeats the subsequent processes. Herein, the portable terminal induces the user to make a speech command appropriate for the status of the second-party terminal and to checks a speech command execution result by displaying the screen of the second-party terminal in the portable terminal. For example, when the second-party terminal receives a Short Message Service (SMS) message during call communication and the user of the second-party terminal is unable to check the SMS message, the user of the portable terminal can receive the screen of the second-party terminal, verify that the second-party terminal has received an SMS message, and transmit a speech command directing to display the SMS message on the display unit of the second-party terminal. Then, it receives a screen from the second-party terminal and checks that the SMS message is displayed as a result of executing the speech command.

In the mean time, when a remote control termination event is created, the portable terminal transmits a remote control termination signal to the second-party terminal in step 213 and the process of the present invention ends.

When a signal rejecting the remote control request is received in step 205, the portable terminal recognizes that it does not have authentication for remotely controlling the second-party terminal with which it is in communication and the process of the present invention ends.

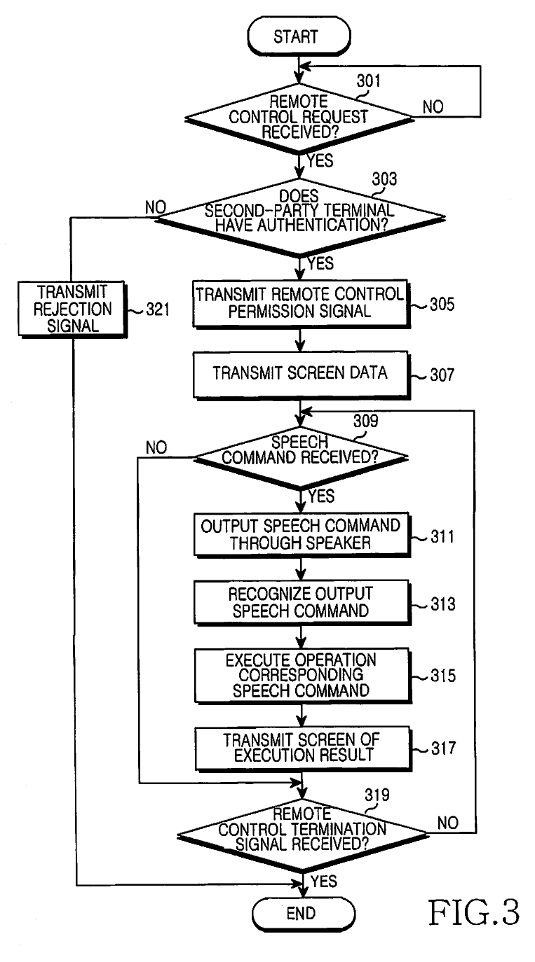

FIG. 3 is a flowchart of a process of receiving a remote control from a second-party terminal during call communication according to the present invention. Referring to FIG. 3, the portable terminal checks whether it has received a remote control request signal from the second-party terminal during call communication in step 301. When the portable terminal receives a remote control request signal, it determines whether the second-party terminal has an authentication for remotely controlling itself. Herein, whether the second-party terminal has an authentication for remotely controlling the portable terminal can be determined by checking whether the second-party terminal is registered as a remote control terminal and requesting the second-party terminal to transmit its authentication number.

When it is determined that the second-party terminal does not have an authentication for remotely controlling the portable terminal, the portable terminal transmits a remote control rejection signal to the second-party terminal in step 321 and the process of the present invention ends.

Conversely, when it is determined that the second-party terminal has an authentication for remotely controlling the portable terminal, the portable terminal transmits a remote control permission signal to the second-party terminal in step 305 and transmits its current screen data that are displayed in the display unit 106 to the second-party terminal in step 307. Herein, the portable terminal can transmit the screen data to the second-party terminal by using a multimedia message.

Subsequently, the portable terminal checks in step 309 whether it receives a speech signal, which is a speech command, from the second-party terminal. When it receives the speech command, the portable terminal outputs the received speech command by use of a speaker phone function in step 311, receives the speech command through a microphone in step 313, and analyzes and recognizes the input speech command. Subsequently, the portable terminal executes operation corresponding to the speech command analyzed and recognized in step 315, and transmits screen data displayed in the display unit 106 as a result of the execution to the second-party terminal in step 317. For example, when the portable terminal receives a speech command ‘SMS message’ from the second-party terminal, the portable terminal verifies that the speech command is ‘SMS message’ based on a speech recognition function, and displays a list of received SMS messages or an unopened SMS message. When an operation of displaying an unopened SMS message is set up for the speech command ‘SMS message,’ the portable terminal displays an unopened SMS message and transmits a screen that the SMS message is displayed to the second-party terminal.

Subsequently, the portable terminal checks whether it receives a remote control termination signal. When it does not receive a remote control termination signal, the portable terminal returns to the step 309 and repeats the subsequent processes. When it receives a remote control termination signal, the portable terminal terminates the process of the present invention.

In the above embodiment, an authentication process is performed to check whether there is an authentication for remote control between portable terminals. However, it is also possible for a portable terminal to remotely control a second-party terminal in communication. Also, although a terminal that desires to remotely control a second-party terminal requests for remote control in the above embodiment, a terminal that desires to be remotely controlled may request the second-party terminal to remotely control itself.

As described above, the present invention makes it possible for a portable terminal to recognize a speech command transmitted from a second-party terminal during call communication, execute an operation corresponding to the speech command to be thereby remotely controlled with a simple speech command. The portable terminal transmits its screen to the second-party terminal that is executing the remote control to help it figure out the exact status of the portable terminal so that the second-party terminal can make an appropriate speech command. Also, the present invention makes it possible to provide diverse services to users who find manipulating a portable terminal to be difficult, such as senior citizens, by communicating with another user and making the user indirectly control their portable terminal. Those who are visually handicapped can check out the contents of an SMS message during call communication by requesting a second-party terminal for remote control, and displaying the SMS message to a user of the second-party terminal, who will make a speech command for opening the SMS message.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the present invention has been described with respect to certain embodiments, it will be apparent to those skilled in the art that various changes and modifications may be made without departing from the scope of the invention, as defined in the following claims.

What is claimed is:

1. A method of receiving in a portable terminal a remote control from a second-party portable terminal, the method comprising:
transmitting a screen displayed in a display unit of the portable terminal to the second-party terminal; and
recognizing a speech signal received from the second-party terminal and executing an operation corresponding to the speech signal.

2. The method of claim 1, further comprising:
transmitting a second screen displayed in the display unit after the executing of the operation to the second-party terminal.

3. The method of claim 1, wherein the recognizing of the speech signal comprising:
outputting the speech signal received from the second-party terminal through a speaker;
receiving the speech signal output from the speaker through a microphone; and
analyzing and recognizing the speech signal input through the microphone based on a speech recognition function.

4. The method of claim 1, wherein the screen is transmitted using one of video communication and multimedia message service.

5. The method of claim 1, further comprising:
performing authentication to check whether the second-party terminal is capable of executing the remote control.

6. A method for remotely controlling a second-party portable terminal, the method comprising:
displaying a screen of the second-party terminal received from the second-party terminal in a display unit; and
transmitting a speech signal input from a user of a first portable terminal to the second-party terminal.

7. The method of claim 6, further comprising:
receiving a screen obtained as a result of the speech signal transmission from the second-party terminal and displaying the received screen in a predetermined position of the display unit.

8. The method of claim 6, wherein the screen is received using one of video communication and multimedia message service.

9. A portable terminal capable of being remotely controlled by a second-party portable terminal, the portable terminal comprising:
a display unit for displaying information generated during an operation of the portable terminal;
a controller for outputting a screen displayed in the display unit to a transceiver, recognizing a speech signal transmitted from the second-party terminal, and executing an operation corresponding to the speech signal; and
the transceiver for transmitting/receiving the screen and the speech signal to/from the second-party terminal.

10. The portable terminal of claim 9, wherein the controller further comprises a speech recognition unit for recognizing and analyzing the received speech signal based on a speech recognition function.

11. The portable terminal of claim 9, wherein the controller executes an authentication process for checking whether the second-party terminal is capable of remotely controlling the portable terminal.

12. The portable terminal of claim 9, further comprising:
a speech output unit for outputting the speech signal received in the transceiver through a speaker; and
a speech input unit for receiving the speech signal output from the speaker through a microphone and providing the speech signal to the controller.

13. The portable terminal of claim 9, wherein the screen is transmitted using one of video communication and multimedia message service.

14. A portable terminal capable of remotely controlling a second-party portable terminal, the portable terminal comprising:
a transceiver for transmitting/receiving a screen and a speech signal to/from the second-party terminal;
a display unit for displaying a screen of the second-party terminal transmitted from the second-party terminal; and
a speech input unit for receiving a speech signal from a user and outputting the speech signal to the transceiver.

15. The portable terminal of claim 14, wherein the screen is transmitted using one of video communication and multimedia message service.
